(19) United States
(12) Patent Application Publication
(10) Pub. No.: US 2014/0210617 A1
(43) Pub. Date: Jul. 31, 2014

(54) System to facilitate well-being checks

(71) Applicant: TimeKeeping Systems, Inc., Solon, OH (US)

(72) Inventors: Barry J. Markwitz, Solon, OH (US); Paolo Argentieri, Richmond Heights, OH (US); Brent G. Bowers, Cuyahoga Falls, OH (US); Dean M. Chriss, Euclid, OH (US); Jason D. Doyle, Mantua, OH (US); John E. Hansley, II, Lyndhurst, OH (US); John W. Hoffman, Mentor, OH (US); Nicholas F. Papatonis, Cuyahoga Falls, OH (US); Roger W. Stahl, Mantua, OH (US); Mary T. Upham, Brecksville, OH (US)

(73) Assignee: TimeKeeping Systems, Inc., Solon, OH (US)

(21) Appl. No.: 13/815,047

(22) Filed: Jan. 28, 2013

(51) Int. Cl. G08B 21/02

(52) U.S. Cl. CPC G08B 21/02
USPC 340/539.13

(57) ABSTRACT

A system for checking the well-being of individuals within an institution is disclosed. The system is comprised of portable wireless devices in the possession of individual(s) who are to perform the well-being checks, a wireless communication network, and a computer device that is connected to the portable wireless devices by the wireless communication network. The computer device executes well-being software and is provided with well-being databases containing the well-being checks to be performed for each person, and has access to a tracking system. The tracking system determines the location of the person on whom such well-being checks are to be performed, the individual performing such well-being checks, and monitors and records whether such well-being checks have been performed.

### TECHNICAL FIELD

The present invention relates, in general, to tracking systems and, more particularly, to a system to check the well-being of persons and which utilizes a tracking system to locate such persons so that well-being checks can be performed and validated.

### BACKGROUND ART

Institutions, such as correctional facilities and psychiatric hospitals, need to check on the well-being of inmates and patients on a periodic basis. Because the persons requiring the well—being checks may be in various locations, such as an assigned room, recreational facility, counseling areas, group therapy sessions, and the like, simply finding the person of interest can be troublesome and time consuming for staff members responsible for performing the well-being checks. Certain types of well-being checks may be required for particular persons but not for others, and the well-being checks performed may vary according to the time of day, current location of the person, and/or the classification of the person to be checked. For example, when the person of interest is in counseling, group therapy, visiting a doctor, or the like, procedures may require that the person of interest be monitored without disturbing the activity that is taking place. Particularly in larger institutions, the difficulty and complexity in performing well-being checks can contribute to mistakes being made in performing the correct checks, or, more importantly, missed checks. This is especially true when manual methods are used for controlling and logging the checks. Additionally, the falsification of paper logs that are used to document well-being checks can be an issue. Even computerized methods that rely only on schedules are cumbersome and error-prone because persons of interest often deviate from predefined schedules due to events beyond their control, and such methods cannot provide any independent validation that the well-being checks actually occurred as scheduled. When well-being checks are not made as required, it is important that supervisors be notified because dire consequences, such as suicide, can result. Additionally, accurate and reliable information regarding well-being checks can help institutions prove compliance with its own policies in addition to governmental rules and mandates, and can be invaluable in situations involving the liability of the institution.

In view of the foregoing inherent problems associated with the prior art well-being checking systems, it has become desirable to develop an automated system that can help institution staff members making rounds, locate persons of interest, instruct staff members as to the type of well-being checks to be performed for each person of interest, reliably log that the staff member and the person of interest were in physical proximity to one another when the well-being check occurred, and notify supervisors or other institution personnel when well-being checks do not occur.

### SUMMARY OF THE INVENTION

The present invention solves the problems associated with the prior art systems for checking the well-being of persons in institutions, and other problems, by providing a system for checking the well-being of such persons and which includes a tracking system to locate such persons so that the necessary well-being checks can be performed. The well-being check system of the present invention comprises portable wireless devices that are in the possession of the individual(s) who perform the well-being checks, a wireless communication network, and a computer device operatively connected to the portable wireless devices. The computer device executes well-being check software and is provided with well-being databases containing the well-being checks to be performed for each person, and has access to a tracking system. Tracking systems utilize various technologies to determine the location of persons and/or objects that are being tracked. Most tracking systems utilize a transponder, transceiver, transmitter or other device or media that is worn by or otherwise carried by a tracked person, or object and which contains a unique identifier that is associated with the tracked person or object. The location of this unique identifier is typically acquired automatically by various methods. These methods include the use of radio triangulation, and/or monitoring check points such as doorways and hallways to detect entry into and exit from rooms and other functional areas, and/or detecting the presence within rooms and other functional areas by means of antennas with controlled fields of view, and other means. Less sophisticated systems may require the manual scanning of media, such as an identification card upon entry into and/or exit from various areas within a facility. Still other tracking systems may use technologies such as facial or other biometric recognition techniques that do not require any device or media to be carried by tracked persons. Regardless of the technology utilized, such systems detect that a tracked person and/or object is present at a particular location or within a particular room or functional area of a facility and provide data describing that location. Some tracking systems provide the locations by means of zone identifiers. A zone can be any defined area and, in practice, zones are usually defined so as to coincide with identified physical and/or functional areas within a facility, such as rooms, buildings, and the like, where persons and/or objects being tracked can be located. Other tracking systems provide position coordinates at which each tracked person and/or object is located, which in turn, can be mapped to physical and/or functional areas (zones) within the facility. The present invention utilizes the zone concept to simplify the data presented to the system user. The system of the present invention requires information related to the location of each person on whom well-being checks are to be performed and the person or persons performing such well-being checks.

### BRIEF DESCRIPTION OF THE DRAWINGS

FIG. 1 is a schematic diagram of the overall well-being check system of the present invention.

FIG. 2 is a schematic diagram of the fundamental components comprising an RFID tracking system which can be utilized by the well-being check system of the present invention.

### DESCRIPTION OF THE PREFERRED EMBODIMENT

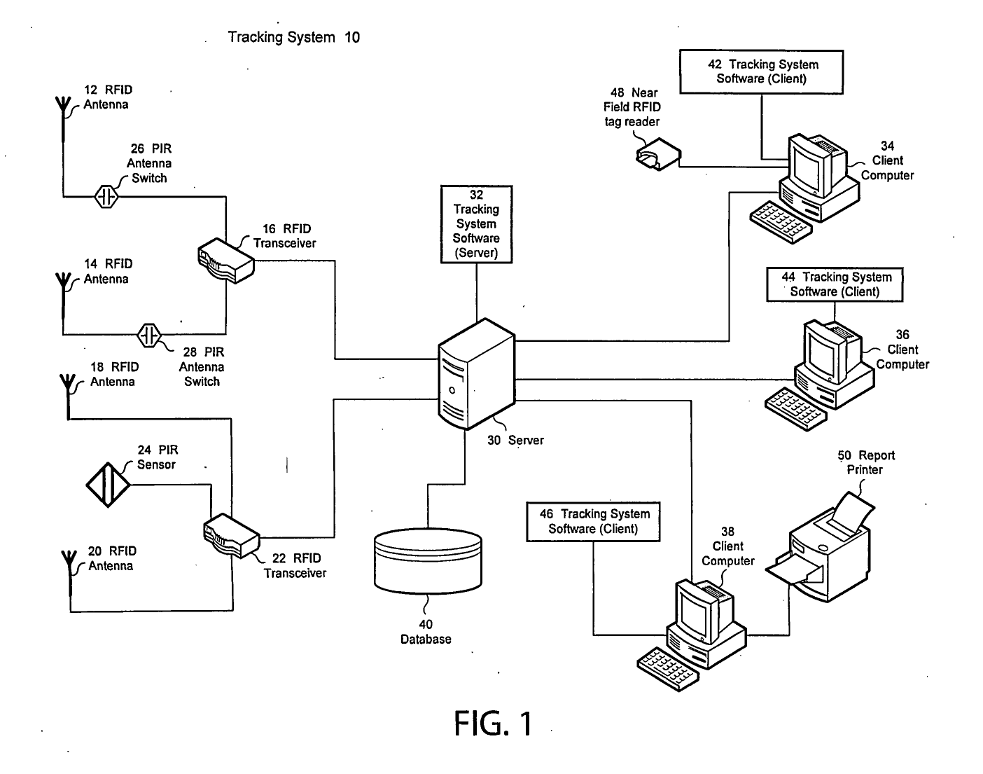

Referring now to the drawings where the illustrations are for the purpose of describing the preferred embodiment of the present invention and are not intended to limit the invention disclosed herein, FIG. 1 is a schematic diagram of the overall well-being check system 10 of the present invention utilizing one or more portable wireless devices, shown generally by the numeral 12. The wireless devices 12 can include PDAs 14, “Smart Phones” 16 and tablet computers 18, each of which having cellular and/or 802.11 (Wi-Fi) capability and incorporating well-being check software. PDAs 14, “Smart Phones” 16 and tablet computers 18 are connectable to a computer 20, via a wireless communication network, shown generally by the numeral 22. The wireless communication network 22 can utilize an existing cellular telephone communication system 24 that is connectable to an existing land-based telephone communication network 26, or to the Internet 28, via an optional intermediate computer 30. A modem or other connection device 32 is utilized to connect the land-based telephone communication network 26 to the computer 20 in order to receive data transmissions from the PDAs 14, “Smart Phones” 16 and tablet computers 18. Alternatively, the computer 20 is connectable to the Internet 28 to receive data transmissions from the PDAs 14, “Smart Phones” 16 and tablet computers 18, via the existing cellular telephone communication system 24. Furthermore, the computer 20 can receive data communications from the PDAs 14, “Smart Phones” 16 and tablet computers 18 directly via a Wi-Fi network 34 based on the IEEE 802.11 specification, or from the Wi-Fi network 34, via the Internet 28. Also, the computer 20 can receive data communications from the PDAs 14, “Smart Phones” 16 and tablet computers 18 from the existing cellular telephone communication system 24, via a cellular data communication device 36.

The computer 20 is provided with well-being check software 38, well-being check database(s) 40, and access to a tracking system, shown generally by the numeral 42. The computer 20 utilizes the well-being check software 38 and the well-being check database(s) 40 to generate commands, as instructed by the well-being check software 38, to produce exception notifications and reports at various output devices, shown generally by the numeral 44, which includes workstations 46, printers 48, and facsimile machines 50. Alternatively, the computer 20 can provide information and notify individuals of exceptions that require attention through email messages 52, PDAs 54, cellular and other telephones 56, or pagers 58.

The portable wireless devices 12, such as PDAs 14, “Smart Phones” 16, tablet computers 18, and the like, are carried by and associated with each staff member who is responsible for well-being checks. The association between staff members and portable wireless devices 12 is accomplished by the staff member logging-in at a particular computing device. These portable wireless devices 12 incorporate well-being check software to facilitate data entry and retrieval for well-being checks and can communicate by means of the wireless communication network 22 with the computer 20.

The computer 20 executes the well-being check software 38 that maintains one or more well-being check database(s) 40 that identify and define all possible types of well-being checks performed at a given institution, all persons requiring well-being checks and for whom these checks are to be monitored by the system 10, the details regarding which well-being checks that apply to each person in the database(s), the frequency at which well-being checks are required for each person in the database(s), procedural rules affecting well-being checks, a history of well-being checks for each person including dates and times when well-being checks were performed, the location at which the checks were performed, and the results of the well-being checks, such as the general demeanor of the person, medication given, and the like. It should be noted that different well-being checks may apply to a given person based on the person's identity, time of day, current location, and other factors. In addition, procedural rules (e.g., clinic visits should not be interrupted for well-being checks) may be used to determine what checks should be performed. Information regarding staff members responsible for performing well-being checks is also stored by the system 10; including staff member identification information, whether the staff members are currently logged in and on duty to perform well-being checks, work schedules of the staff members, and the like.

Additionally, the well-being check software 38 must acquire location data for the appropriate persons from the tracking system 42. The tracking system must be capable of determining at least the location of staff members who are on duty and responsible for performing well-being checks and persons requiring the well-being checks. It should be noted that the location data required by the system 10 for staff members and persons of interest need not consist of precise locations. Instead, locating the staff member and/or persons of interest within the boundaries of a particular room or other defined area within the particular institution is adequate and preferred.

For each person requiring a well-being check, the system 10 maintains a “well-being check currently due” indicator that is set when a well-being check is currently due, based on the frequency at which the checks are to occur for a given person. The operation of the foregoing is configurable to accommodate the rules of various institutions. For example, a well-being check for a particular person might be required at 11:00 A.M. The system of the present invention can be configured to set this well-being check as currently due during a time interval, such as between 10:55 A.M. and 11:05 A.M. The 11:00 A.M. well-being check would then be permitted only at a time during that particular time interval, and after 11:05 A.M., the well-being check scheduled for 11:00 A.M. would be flagged as having been “missed”.

The portable wireless devices 12 can advise staff members as to which persons are currently due for a well-being check. Staff members responsible for performing well-being checks can then request the location of any such person via the well-being check software 38 executing in the computer 20. A specific portable wireless device 12 communicates this request to the computer 20 via the wireless communication network 22. Upon receipt of this request, the computer 20 acquires the requested location information from the tracking system 42. This location information along with the specific well-being check to be performed by the staff member and other pertinent data obtained or derived from the well-being check database(s) 40 by the computer 20 is then sent to the portable wireless device 12 via the wireless communication network 22. When received by the portable wireless device 12, the well-being check software therein causes the relevant information to be displayed to the staff member in user friendly format. Only when a staff member responsible for performing well-being checks is in proximity to the person requiring the well-being check are fields for entering information regarding the well-being check made available to the staff member, thus removing the ability of to falsifying the well-being checks. When the well-being check has been performed, the staff member enters information regarding the person's well-being into the portable wireless device 12 which sends the information, via the wireless communication network 22, to the computer 20 which, in turn, updates information in the well-being check database(s) 40. In addition, the location at which the well-being check was performed is stored in the well-being check database(s) 40. When the well-being check has been completed, the previously described “well-being check currently due” indicator is cleared, indicating that the particular person is no longer currently due for a well-being check.

When a particular well-being check has been missed based on the expected frequency of occurrence, a missed well-being check is stored in the well-being check database(s) 40. The missed well-being check includes identification and location information of the person who was to be checked, identification and location information of the staff members who were on duty performing well-being checks, and other pertinent information. When the foregoing occurs, an alert can be sent via the wireless communication network 22 to any or all of the portable wireless devices 12 for display by the well-being software incorporated therein. Notifications can also be sent by the computer 20 to supervisory staff via one or more output devices 44 accessible by the computer 20. Missed well-being check information is included in exception reports that can be generated by the system 10 on one or more output devices 44 accessible by the computer 20.

Additionally or alternatively, the system 10 can function as previously described except that the well-being check software 38 determines, via the tracking system 40, when roaming staff members responsible for performing well-being checks are in proximity of persons who are currently due for such checks. When this occurs, the well-being check software 38 can cause the computer 20 to send appropriate information to a particular staff member, such as the names and/or photographs of persons who are in proximity of the staff member and who also have their associated “well-being check currently due” indicator set, the types of check(s) to be performed for each person, and the like, via the wireless communication network 22, for display on the appropriate portable wireless device 12. For example, when a staff member responsible for well-being checks enters or approaches a room in which persons requiring well-being checks are present, the system 10 can determine whether any person in the room is currently due a well-being check and, if so, the appropriate information is displayed on the staff member's portable wireless device 12. This information can be displayed graphically using a map or floor plan and various icon colors or shapes to indicate persons of interest and the checks to be performed, textually, or a combination of graphics and text, which is the preferred format. Regardless of the type of display utilized, the information includes identification information for the persons on whom the staff members should check and the checks that should be performed by the staff member for each person. The staff member can select from among the indicated individuals and enter information relating to each individual's well-being. As previously discussed, this information is communicated back to the computer 20, which updates information in the well-being check database(s) 40 and maintains indicators relating to the well-being checks. Also, as previously discussed, the system 10 does not provide an opportunity to enter well-being check information for persons who are not presently in proximity of the staff member responsible for performing such checks.

Because the system 10 can determine the date, time, and location at which a particular well-being check occurs, the system can use these factors in conjunction with procedural rules in the well-being check database(s) 40 to determine which well-being check should be performed, or how the well-being check should be performed or modified, and instruct the staff member performing the well-being check accordingly. For example, taking a blood pressure reading may be part of a well-being check. Based upon procedural rules in the well-being check database(s) 40, the staff member might be instructed not to take the blood pressure reading if the person to be checked is in a particular room at a particular time of day and is sleeping. Since the system 10 can determine the current time and the location of the person to be checked, the system would only need to display an instruction such as “Do not check blood pressure if person is asleep” when such an instruction is appropriate.

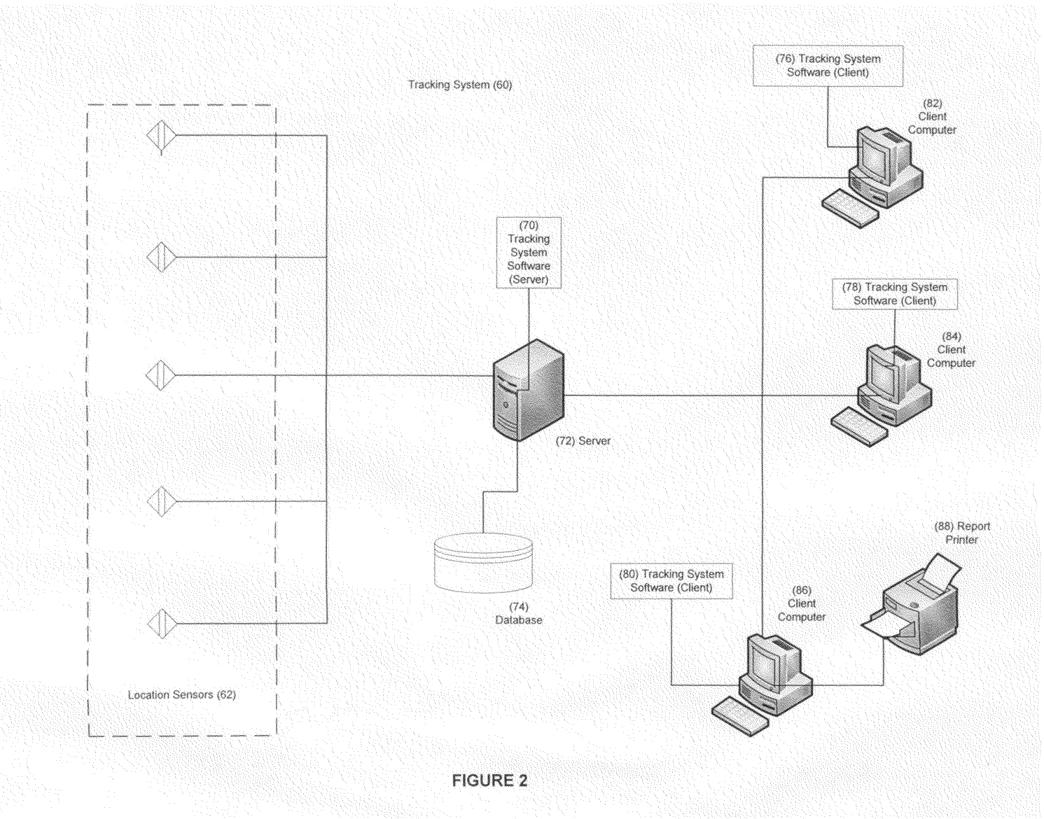

As previously discussed, the system 10 requires access to data from a tracking system 42 that is capable of determining the location of staff members responsible for performing well-being checks and persons requiring well-being checks. Because institutions, such as correctional facilities and psychiatric hospitals, often have computerized systems in place to track inmates and patients, it is envisioned that the present invention could acquire this location data from any existing computerized tracking system that has already been implemented. This is accomplished by connecting such systems to a common network, typically a LAN, and the well-being check software requesting location data as required through either an existing or customized software interface between the well-being check system and the tracking system. Alternatively, the system 10 can include a computerized tracking system 60, the basic components of which are shown schematically in FIG. 2. The tracking system 60 gives the system users the ability to determine the location of monitored persons within a facility at any given time.

Referring now to FIG. 2, a schematic diagram of the fundamental components comprising the tracking system 60 is illustrated. As shown in this Figure, a number of location sensors 62 are distributed throughout the monitored facility. These sensors 62 may all use the same technology or the technology employed may vary among the sensors according to the circumstances of the installation. In all instances both the identity and the location of the tracked person can be determined by the tracking system software 70. For example:
1. The sensors 62 may be two or more fixed antennas and associated receivers or transceivers that are used to triangulate the position within the facility of small portable active radio transmitters or transceivers that are worn by persons being tracked by the system. These small portable radio transmitters or transceivers transmit a unique identifier either continuously, periodically, or when interrogated by the fixed antennas and their associated transceivers. The unique identifier is received by the fixed antennas and their associated receivers and transceivers and is subsequently associated by the tracking system software 70 with the person wearing or otherwise carrying the portable transmitter or transceiver, thus providing the identity of the person being tracked. The location of the person being tracked is calculated using triangulation methods and is then mapped to a room or zone within the facility by the tracking system software 70, thus also providing the location of the tracked person.
2. The sensors 62 may be RFID antennas and transceivers that activate RFID transponders worn or otherwise carried by persons being tracked. When the RFID transponder is activated by a RFID transceiver, the unique identifier contained within the transponder is communicated to the transceiver. The unique identifier is associated by the tracking system software 70 with the person wearing or otherwise carrying the transponder, thus identifying the person. Because the field of view of the RFID antennas can be well controlled and localized, the location of the person can also be determined by the tracking system software 70 by determining which antenna received the identifier.
3. The sensors 62 may be identification card readers such as bar code, near field RFID, smart card, and the like, that the tracked persons are required to scan when they enter and exit various locations within the facility. While less reliable than the automatic identification methods previously discussed, the tracking system software 70 is able to acquire the unique identifier from the card, associate it with a particular person, and determine the location of the person based on the location of the identification card reader that produced the identifier. The tracking system software 70 determines that a particular person is at a particular location such as a room or other functional area until that person scans his or her identification card again to exit, and/or scans his or her identification card using a different identification card reader to enter a different location.
4. The sensors 62 may be biometric scanners such as fingerprint, retina, facial recognition, and the like, that tracked persons are required to use when entering and exiting various locations within a facility. The tracking system software 70 is able to determine the identity of the tracked person by these biometric means and the location of the person is determined based on the location of the biometric scanner utilized. The tracking system software 70 determines that a particular person is at a particular location such as a room or other functional area until that person again uses the biometric scanner to exit that location and/or uses a biometric scanner at a different location to enter that location.

The location sensors 62 are connected to a server 72 via a network, typically a LAN, (localized area network). The server 72 executes tracking system software 70 that incorporates logic such as that previously described, which provides a determination of areas or zones in which tracked persons are located. These location determinations are time stamped and stored in the database 74 for later use. Current and historical location information is available for display by client computers 82, 84 and 86 connected to the same network and executing tracking system client software 76, 78 and 80, respectively. The client computers 82, 84 and 86 can also print historical location information for tracked persons on a report printer 88. Additionally, the tracking system software 70 allows system administrators to configure the system 60 and update firmware, if any, in the location sensors 62, typically via the client computers 84, 86 and 88.

Certain modifications and improvements will occur to those skilled in the art upon reading the foregoing. It is understood that all such modifications and improvement have not been included herein for the sake of conciseness and readability, but are properly within the scope of the following claims.

We claim:

1. A system to monitor the status of a person to determine whether a task has been performed for said person within a plurality of persons comprising at least one portable wireless device, a wireless communication network, a computer device operatively connected to said at least one portable wireless device by said wireless communication network permitting communication between said at least one portable wireless device and said computer device, said computer device including means defining said tasks to be performed for said plurality of persons and databases containing said tasks, a tracking system for monitoring the location of said plurality of persons within a physical area, and identification means associated with each person within said plurality of persons and containing a unique identifier for each said person within said plurality of persons, said identification means transmitting said unique identifier to provide the identification and the location of said person within said physical area and to determine whether said task has been performed for said person.

2. The system as defined in claim 1 wherein said at least one portable wireless device comprises PDAs, “Smart Phones”, and tablet computers.

3. The system as defined in claim 1 wherein transmission of said unique identifier by said identification means is periodic in nature.

4. The system as defined in claim 1 wherein said tracking system utilizes RFID technology and said identification means is an RFID tag.

5. The system as defined in claim 1 wherein said tasks relate to the well-being of said person.

6. The system as defined in claim 1 further including peripheral equipment operatively connected to said computer device.

7. A system to monitor the status of a person to determine whether a task has been performed for said person within a plurality of persons comprising at least one portable wireless device, a wireless communication network, a computer device operatively connected to said at least one portable wireless device by said wireless communication network permitting communication between said at least one portable wireless device and said computer device, said computer device including means defining said tasks to be performed for said plurality of persons and databases containing said tasks, a tracking system for monitoring the location of said plurality of persons within a physical area, and identification means associated with each person within said plurality of persons and containing a unique identifier for each said person within said plurality of persons, said tracking system activating said identification means causing said identification means to transmit said unique identifier to provide the identification and the location of said person within said physical area and to determine whether said task has been performed for said person.

8. The system as defined in claim 7 wherein said at least one portable wireless device comprises PDAs, “Smart Phones”, and tablet computers.

9. The system as defined in claim 7 wherein activation of said identification means by said tracking system is periodic in nature.

10. The system as defined in claim 7 wherein said tracking system utilizes RFID technology and said identification means is an RFID tag.

11. The system as defined in claim 7 wherein said tasks relate to the well-being of said person.

12. The system as defined in claim 7 further including peripheral equipment operatively connected to said computer device.
